(19) United States
(12) Patent Application Publication
(10) Pub. No.: US 2009/0304435 A1
(43) Pub. Date: Dec. 10, 2009

(54) REMOVABLE RIVETS AND RELATED METHODS

(76) Inventors: Darren S. Ferris, La Habra Heights, CA (US); Donn W. Meade, Chicopee, MA (US); Richard K. Joyner, Meridian, MS (US)

Correspondence Address: AVERY DENNISON CORPORATION;Patent Group, Law Department - 3 South, P.O. BOX 7090, PASADENA, CA, 91109-7090, US

(21) Appl. No.: 12/134,175

(22) Filed: Jun. 5, 2008

(51) Int. Cl. B42F 13/16; F16B 19/10; B21J 15/02

(52) U.S. Cl. 402/27; 411/34; 29/525.06

(57) ABSTRACT

A rivet assembly includes a tube with first and second ends and a spiral thread formed on an inner surface extending from the first end to a first axial extent, and a bolt formed to engage the tube thread to a second axial extent less than the length of the tube.

### TECHNICAL FIELD

This disclosure relates to rivets and exemplary uses thereof.

### BACKGROUND

Rivets are among the most fundamental methods of fastening two workpieces together, and still among the most economical. Rivets come in a variety of configurations, for example, solid rivets, blind rivets, multi-grip rivets, grooved rivets, peel type blind rivets, self-pierce rivets, plastic rivets, tubular rivets, and others. A common feature of rivets is that they are intended for permanent, non-reversible attachment. Where reversible attachment is required, the well known nut and bolt, or a variant thereof, is typically employed. However, combining the rivet's superior holding power and low cost (as compared to nuts and bolts or the like) with the ability to easily and/or non-destructively detach the workpieces is sometimes desirable, for example, when dismantling a product for disposal or recycling. As one non-limiting example, ring binders are typically assembled from a metal binding mechanism riveted to a paper or plastic cover. Being able to easily detach the binding mechanism from the cover would allow easier and more complete recycling of the two different materials (metal and paper/plastic), while still keeping the cost of assembling the binder in the first place at economical levels.

Various attempts have been made to create such removable rivets. U.S. Pat. No. 3,193,921 to Kahn (the “Kahn patent”), for instance, which is incorporated by reference in its entirety herein, discloses a blind rivet assembly consisting of a tubular shank that is inserted through the cooperating holes in the workpieces to be joined. A threaded tap is threaded into the shank so as to engage a reduced-diameter distal portion of the shank, thereby swaging a corresponding thread on the inner surface of the shank and simultaneously drawing the distal end of the shank towards the workpieces to assume an expanded, bulbous configuration. However, as can be best appreciated from the drawings (e.g., FIG. 2) of the Kahn patent, this results in a final product where the bulbous end projects to a non-insignificant extent from the workpiece surface. Furthermore, as can be seen in FIGS. 2, 4, 6, 8 and 10 of the Kahn patent, the size of the bulbous enlargement is not significantly larger than the insertion hole, and thus, it appears that the mechanical strength afforded by this device may not be as great as a more conventional peened rivet. Finally, it is also questionable whether the threaded tap could be easily removed when so desired, due to the tight bond formed between the tap and the shank by the cold flow of the shank material engendered by the swaging action.

A rather similar approach is taken in U.S. Pat. No. 3,842,710 to Poupitch (the “Poupitch patent”), which is incorporated by reference in its entirety herein, which also provides a tubular shank inserted through the workpieces and a screw body inserted into the shank. However, instead of swaging the screw into the shank, the Poupitch patent discloses closing off the other end of the shank and, once inserted through the workpieces, the closed end of the shank is deformed into a rivet head by peening. The peening cold flows the material at the closed end of the shank around the threads of the screw and secures the two together. This approach results in a more conventional rivet assembly than the Kahn patent provides, but, like the rivet of the Kahn patent, it is also questionable whether the screw could be easily removed when desired due to the tight bond formed between the screw and the tubular shank by the cold flow of the shank material engendered by the swaging action. Furthermore, the rivet assembly of the Poupitch patent requires that the screw be made from a harder material than the shank so as to withstand the deforming forces applied to the shank without any damage to its threads (which would otherwise preclude eventual disassembly).

What is still needed is a method and apparatus for securely, economically, and reversibly riveting objects together. The embodiments of the present disclosure address these and other needs.

### SUMMARY

In a first embodiment disclosed herein, a rivet assembly includes a tube having first and second ends with a spiral thread on an inner surface extending from the first end to a first axial extent, and a bolt configured to engage the spiral thread to a second axial extent that is less than the length of the tube. In another embodiment, the bolt has a substantially planar head.

In two further embodiments, the first axial extent equals the length of the tube and the first axial extent equals the second axial extent.

In additional embodiments, the tube is made of a malleable material, and the tube and bolt can be made of the same material or different materials. The first and second ends of the tube can be open ends.

In a further embodiment disclosed herein, a method of riveting two objects together includes providing two objects, providing a tube with first and second ends and an inner surface having a spiral thread extending an axial length, providing a bolt configured to engage the spiral thread from the first end to a second axial extent, threading the bolt into the first end of the tube, aligning the two objects, inserting the tube through both objects and deforming the second end of the tube.

A further embodiment includes a method for riveting two objects together wherein each object includes at least two perforations, aligning the perforations and inserting the tube through the aligned perforations.

Yet another further embodiment includes punching the tube through at least one of the objects.

Yet another further embodiment includes the step of threading the bolt into the first end of the tube before the step of inserting the tube through the two objects.

Another embodiment includes a ring binder having a binder cover with a front cover, a back cover and a spine hingedly connecting the front and back covers. The ring binder also includes a ring mechanism attached to the binder cover and at least one rivet assembly. The rivet assembly including a tube and a bolt. The tube having first and second ends and a spiral thread on an inner surface extending from the first end to a first axial extent. The bolt is configured to engage the spiral thread to a second extent that is less that an axial length of the tube. The rivet assembly is disposed through the ring mechanism and the binder cover and at least a portion of the tube is deformed so that the ring mechanism is fastened to the binder cover.

Yet another embodiment includes the method for forming a ring binder having the steps of providing a binder cover including a front cover, a back cover and a spine hingedly connecting the front and back covers, providing a ring mechanism, providing a rivet assembly including a tube and a bolt, aligning the binder cover and ring mechanism, disposing the rivet assembly through the ring mechanism and binder cover. The tube includes first and second ends, an axial length and a spiral thread on an inner surface extending from one end to a first axial extent. The bolt engages the spiral thread to a second axial extent that is less than the axial length of the tube resulting in the non-engaged extent. The method also includes the step of deforming the non-engaged extent of the tube to fasten the ring mechanism to the binder cover.

These and other features and advantages will become further apparent from the detailed description and accompanying figures that follow. In the figures and description, numerals indicate the various features, like numerals referring to like features throughout both the drawings and the description. The figures are not drawn to scale and should not be interpreted as such.

### BRIEF DESCRIPTION OF THE DRAWINGS

FIG. 1 is a sectional view of a rivet assembly having a rivet tube and a bolt shown in an assembled state according to a preferred embodiment;

FIG. 2a is a sectional view of a rivet tube according to a preferred embodiment;

FIG. 2b is a side elevation of a bolt according to a preferred embodiment;

FIG. 3a is a sectional view of the rivet assembly of FIG. 1 inserted through two objects according to a preferred embodiment;

FIG. 3b is a sectional view of the rivet assembly of FIG. 3a after peening the rivet assembly to hold the two objects in place according to a preferred embodiment;

FIG. 4a is a perspective exploded view of a binder including the rivet assembly of FIG. 1 according to a preferred embodiment;

FIG. 4b is a perspective exploded view of another binder using the rivet assembly of FIG. 1 according to a preferred embodiment;

FIG. 4c is a perspective view of the inside of the assembled binders of FIGS. 4a and 4b according to a preferred embodiment;

FIG. 4d is a perspective view of the outside of the assembled binders of FIGS. 4a and 4b according to a preferred embodiment;

FIG. 5a is a perspective exploded view of another binder using the rivet assembly of FIG. 1 according to a preferred embodiment;

FIG. 5b is a perspective exploded view of another binder using the rivet assembly of FIG. 1 according to a preferred embodiment;

FIG. 5c is a perspective view of the inside of the assembled binders of FIGS. 5a and 5b according to a preferred embodiment;

FIG. 5d is a perspective view of the outside of the assembled binders of FIGS. 5a and 5b according to a preferred embodiment; and

FIG. 6 is a partial plan view of the top of a peened rivet assembly of FIG. 1 in use according to a preferred embodiment.

### DETAILED DESCRIPTION OF THE PREFERRED EMBODIMENTS

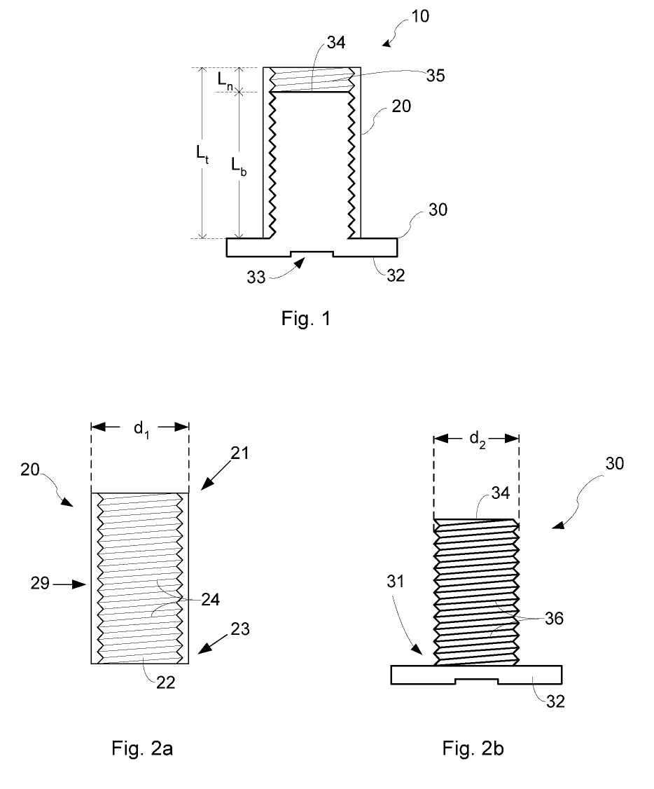

Referring to FIG. 1, in one exemplary embodiment in accordance with the present disclosure, a rivet assembly 10 includes a tube 20 and a bolt or screw 30. Referring additionally to FIG. 2a, the inner surface 22 of the tube has a thread 24 that in a preferred (and shown) embodiment is a spiral thread extending between both ends 21, 23 of the tube; however, it is understood that the present disclosure contemplates embodiments where the thread extends from one end of the tube to an axial extent along the tube that is less than the fill length of the tube, and also where the thread extends only in a central portion 29 of the tube and doesn't engage either end. The tube also has an outer diameter d₁ that is suitable for inserting through workpieces to be attached to one another using the rivet assembly, as described below.

Referring additionally now to FIG. 2b, the bolt 30 can be made in a typical configuration with a slotted head 32 attached to one axial end 31of a threaded shank 34. The threaded shank is matched to the tube 20, that is, it is configured with a spiral thread 36 matching the thread 24 of the tube and the threaded shank has a diameter d₂ selected so that the bolt can be threadably inserted into the tube, as shown in FIG. 1 and described elsewhere herein. In the embodiment shown, the slotted head is provided with a planar (i.e., flat) configuration, but it must be understood that any and all other practicable configurations (e.g., semi-spherical) are contemplated herein.

The skilled person will also understand that the bolt 30 can be made with a head 32 having any other means for being driven other than a slot 33 for a straight screwdriver as in the embodiment of FIG. 1. Thus, the head of the bolt can be made with a Phillips screwdriver slot (that is, a cross-shaped recess), a hexagonal recess for receiving an Allen wrench therein, or any other shape of recess for receiving an appropriately shaped and sized driver bit therein, including but not limited to square, star (of any number of points), triangular, and irregular. Alternatively, the head itself may be shaped, for example, hexagonally-shaped, to interface with a wrench or other driver.

With reference to FIG. 1 now, the bolt shank 34 is made with an overall length “L_{b}” that is shorter than the overall length “Lₜ” of the tube 20, so that upon threading of the bolt 30 through an end 23 of the tube and up to its maximum extent, a length “Lₙ” of a portion 35 of the interior of the tube from its opposite end 21 remains empty and non-engaged with the bolt. As shown, in the preferred embodiment, both ends 21, 23 of the tube are open so that one end can receive the bolt shank therein and the other end can facilitate assembly as discussed elsewhere herein.

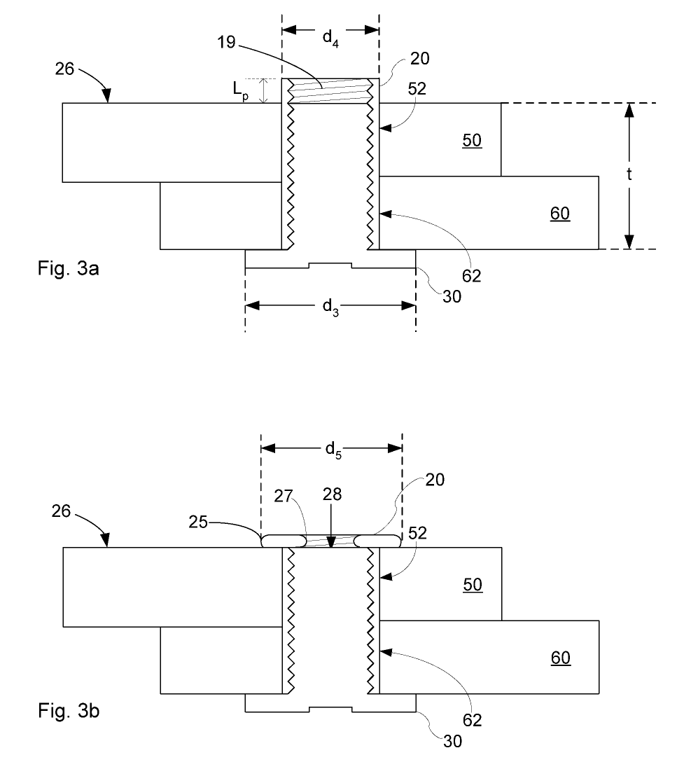

Referring additionally to FIG. 3a, in use, the rivet assembly 10 is assembled as shown in FIG. 1 and inserted through cooperating holes 52, 62 made in workpieces 50, 60, respectively, and aligned coaxially. Preferably, holes 52, 62 are of the same diameter “d₄”, however, the holes can be of different diameters as long as the diameter “d₁” of the tube 20 is smaller than that of the holes. It will be appreciated that the diameter “d₃” of the head 32 of the bolt 30 is greater than the diameter “d₄” of the cooperating hole 62. Ideally, the length “L_{b}” of the bolt will be as nearly equal as practical to the overall thickness “t” of the stacked workpieces 50, 60. As further shown, the tube is selected so that the length “Lₜ” of the tube is greater than the overall thickness of the stacked workpieces and an empty portion 19 of the tube extends from the top surface 26 of the top workpiece 50. The bolt can be selected so that it is equal in length to the overall thickness of the stacked workpieces, as in the embodiment shown in FIG. 3a. Thus, the length “Lₚ” of the portion of the tube that extends from the top surface of the top workpiece is equal to the length “Lₙ” of the empty interior portion 35. Alternatively, the bolt can be selected so that it's length is less than the overall thickness of the stacked workpieces. In this case, the length “Lₚ” is less than the length “Lₙ” of the empty interior portion 35.

At this point, and as additionally shown in FIG. 3b, the rivet assembly 10 is secured to the two workpieces 50, 60 in a conventional manner, that is, by deforming the empty portion 19 that extends above the top surface 26 of the top workpiece 50 (e.g., by peening or any other deforming method) so that the deformed portion 25 assumes a diameter “d₅” that is larger than the diameter “d₁” of the tube 20 and the diameter “d₄” of the cooperating hole 52 and preferably engages the top surface of the top workpiece to thereby cooperate with the bolt head 32 to secure the two workpieces together. As the skilled person will appreciate, the provision of an open end in the empty portion 19 allows such deformation to be performed without undue effort, and can further allow a portion 27 of the material of the tube to cold flow inwards to contact the top surface 28 of the bolt shank 34 (as clearly shown in FIG. 3b).

As will readily be understood by the skilled reader, should the two workpieces 50, 60 need to be separated, all that is required is removal of the bolt 30 from the tube 20 in the conventional manner of bolts, that is, by engaging the slotted head 32 with an appropriate tool, for example, a screwdriver, a coin, a hexagonal or Allen wrench, or any other appropriate driver bit as explained above, and driving the bolt rotationally so as to disengage the threaded shank 34 from the thread 24 of the tube. The bolt can be readily removed from the tube since the deformed portion 25 does not interface with the threaded shank of the bolt. The separation of the two workpieces is easily accomplished because there are no additional permanent adhesives or fastening means holding the two workpieces together. Thus, just about anyone can accomplish this procedure with a very wide variety of tools or everyday objects.

In alternative embodiments, additional adhesive materials can be used (for example, VIBRA-TITE™ available from ND Industries of Troy, Mich. and LOCTITE® available from Henkel North America of Avon, Ohio) to prevent the bolt 30 from vibrating and prematurely disengaging from the tube 20. The adhesive material can be applied to the thread shank 34 prior to assembly with the tube 20. This may prove to be useful in such applications where preassembled rivet assemblies in accordance with the present disclosure (for example, the rivet assembly 10 shown in FIG. 1) are used with conventional automated riveting equipment of the types well known in the art, and where the rivet assembly could become partially disassembled during deployment, for example, in the hopper of an such an automatic riveting machine.

Those skilled in the art will also immediately appreciate that it is preferable to use a wide range of deformable or malleable materials for manufacturing the tube 20, ranging from plastics to metals, for example, aluminum, brass, copper, nickel, and other types of alloys. The skilled person will further appreciate that the material for manufacturing the rivet assembly 10 of the present disclosure can be selected in view of its intended use, including the strength of the fit desired, the size and configuration of the workpieces to be attached together, and the material from which the workpieces are made. Furthermore, rivet assemblies according to the present disclosure can be made from the same material for both constituent pieces (tube 20 and bolt 30) or from different materials for the two pieces.

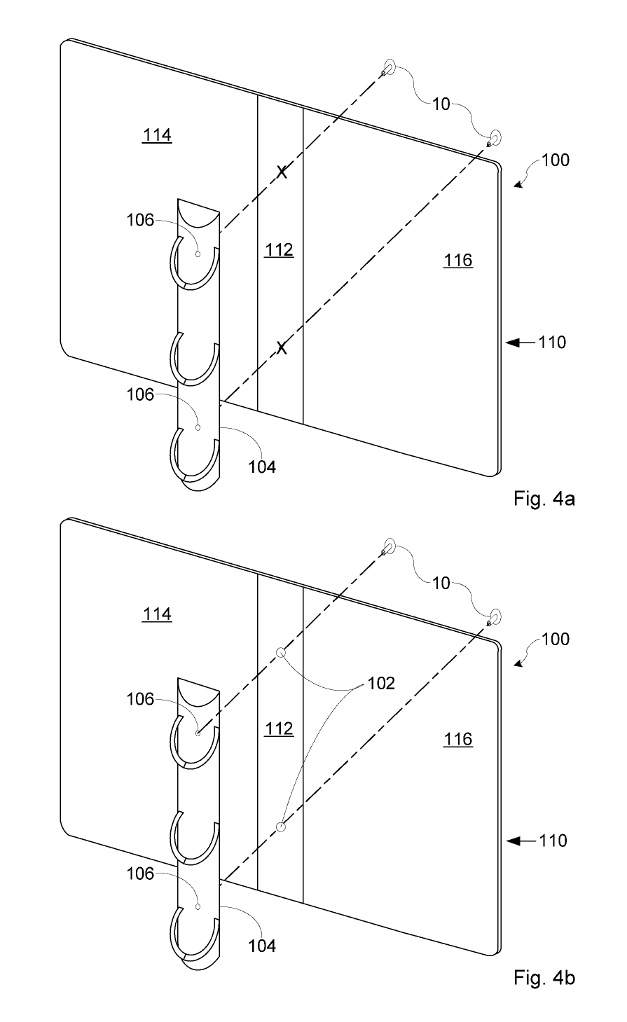

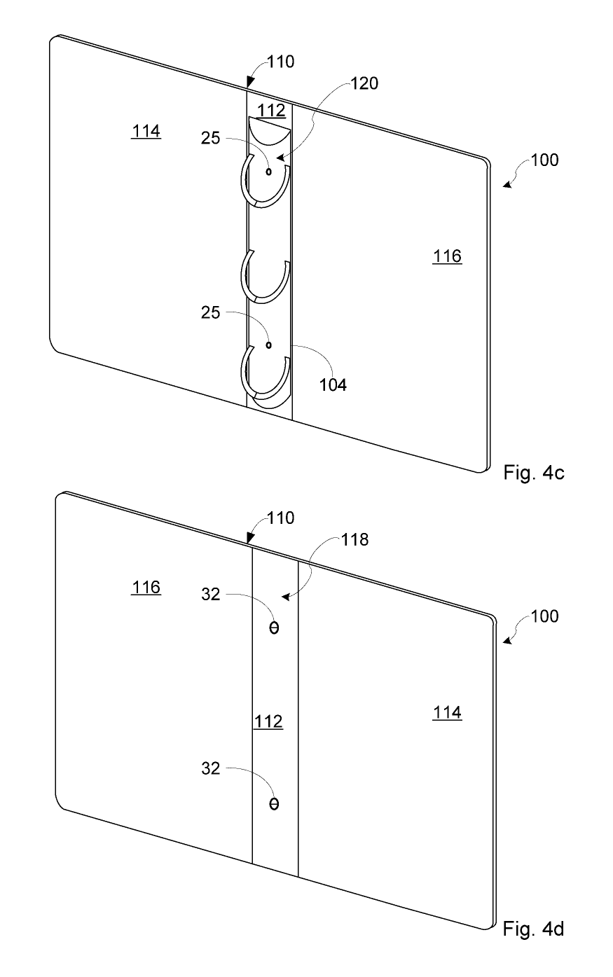

Those skilled in the art, as well as others, will further readily appreciate the wide variety of uses for the removable rivet assembly 10 described herein. For instance, in one exemplary and non-limiting embodiment as illustrated in FIGS. 4a through 4d, one or more rivet assemblies 10 as described elsewhere herein can be used in assembling a binder having a plurality of rings, for example, a three-ring binder 100 of the type well known in the art. The word “plurality”, as used herein, means two or more.

Such a three ring binder 100, as shown in FIG. 4a, is typically made with a ring mechanism 104 fastened to a ring binder cover 110 along a spine 112 thereof so that the two flaps 114, 116 of the cover on either side of the spine can be folded along the spine to encompass the ring mechanism and any sheets fastened therein. In accordance with the present disclosure, the ring mechanism can be fastened to (and thus, also easily unfastened from) the ring binder cover with one or more rivet assemblies 10 disposed through holes 106 made in the ring mechanism and punched through the spine of the ring binder cover, as in the embodiment of FIG. 4a. Alternatively, as shown in the embodiment of FIG. 4b, the spine can have pre-drilled holes 102 for the rivet assemblies to pass through. As shown in FIGS. 4c and 4d, after joining the ring mechanism to the ring binder cover spine and inserting the rivet assemblies therethrough so that the bolt heads 32 are intimately engaging the outside surface 118 of the ring binder (that is, on the other side of the spine from which the ring mechanism is attached), the empty portion 19 of the tube 20 of each rivet assembly is deformed as described previously herein. The deformation is such that at least part of the deformed portion 25 extends beyond the diameter d₄ of the hole and at least partially overlaps the surface 120 of the ring mechanism to thereby cooperate with the respective bolt head to secure the ring mechanism and ring binder cover together.

Three-ring binders 10 suitable for use with the rivet assemblies 10 can be found, for example, in U.S. Pat. No. 5,441,357 to Wilson (see FIGS. 1 and 2, and col. 4 lines 50-52); U.S. Pat. No. 5,607,246 to Podosek (see FIGS. 4, 6 and 9, and col. 6 lines 15-19); and U.S. Pat. No. 5,620,207 to Podosek, et al. (see FIGS. 1, 2, 21, and 22, and col. 4 lines 50-56 and col. 8 lines 49-56), all of which are incorporated by reference in their entirety herein. Additionally, a wide variety of ring mechanisms 104 that are suitable for use with the rivet assemblies can be found, for example, in U.S. Pat. No. 5,476,335 to Whaley; U.S. Pat. No. 5,577,852 to To; U.S. Pat. No. 5,816,729 to Whaley; U.S. Pat. No. 6,749,357 to Cheng; U.S. Pat. Appl. Pub. 2008/0075526 to Ng, et al.; and U.S. Pat. Appl. Pub. 2008/0075527 to Pi, et al., all of which are incorporated by reference in their entirety herein. None of these exemplary binders or ring mechanisms is intended to be limiting examples.

As discussed in the example above, the bolt head 32 is adjacent to and engages the outside surface 118 of the binder 100. However, in alternative embodiments, the bolt head can be intimately engaging the surface 120 of the ring mechanism inside of the ring binder cover 100 (that is, on the same side of the cover as that to which the ring mechanism is attached) so that the deformed portion 25 of the rivet assembly 10 is adjacent to the outside surface of the binder and the bolt head is adjacent to the ring mechanism.

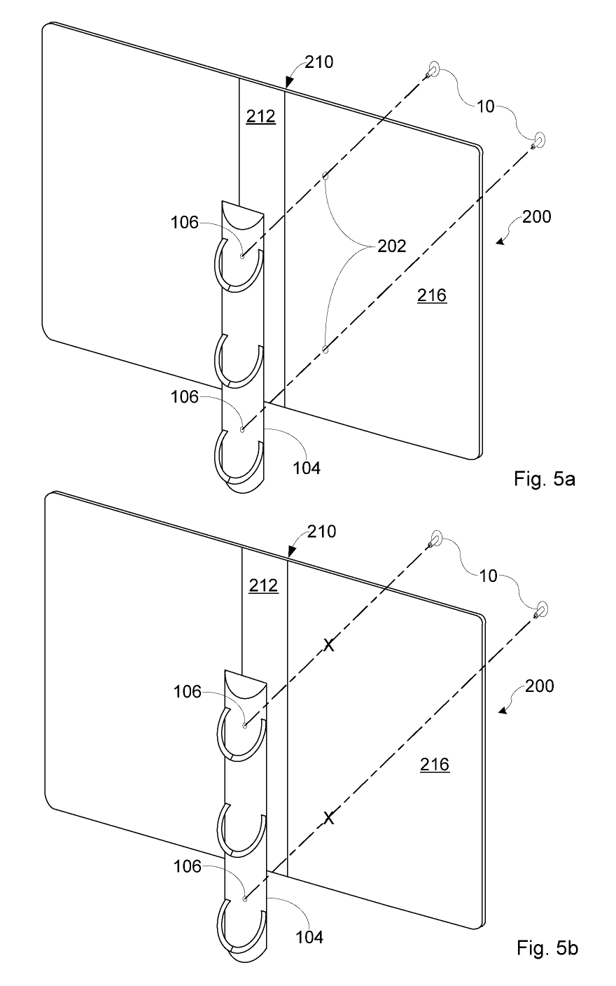

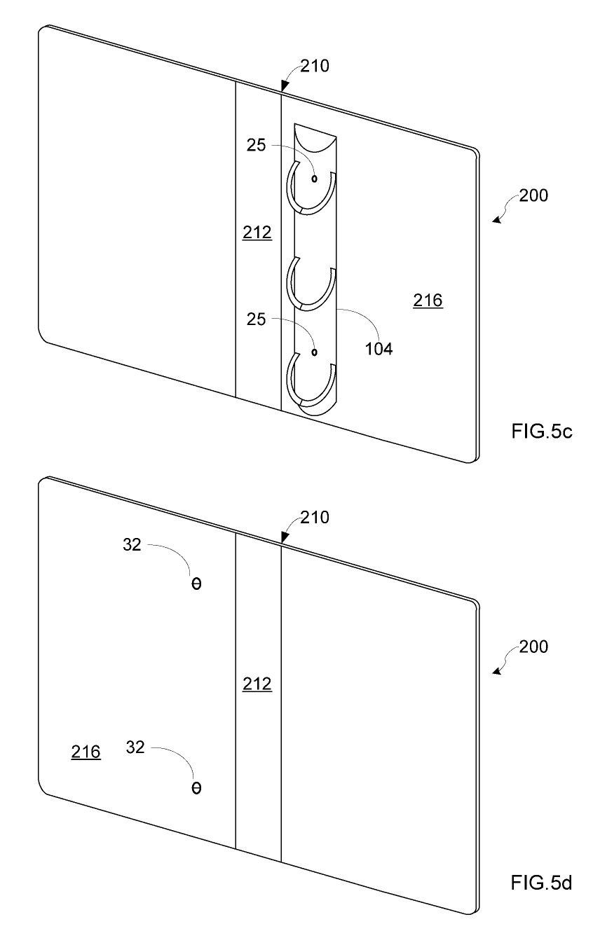

In still other alternative embodiments, as shown, for example, in FIGS. 5a through 5d, a three ring binder 200 can be made as previously described but, rather than having a ring mechanism 104 fastened to a ring binder cover 210 along a spine 212 thereof, the ring mechanism can be fastened to a flap 216 thereof. In the embodiment of FIG. 5a, the rivet assemblies 10 are inserted through holes 106 in the ring mechanism and holes 202 that are preformed in the ring cover flap. An alternative embodiment is shown in FIG. 5b in which the rivet assemblies are inserted through holes in the ring mechanism and punched through the ring cover flap without preforming the holes. After insertion of the rivet assemblies, the empty portion 19 of the tube 20 of each rivet assembly is deformed as described previously herein so that the deformed portion 25 assumes a diameter “d₅” larger than the diameter “d₄” of the hole 106 and engages the surface 120 of the ring mechanism to thereby cooperate with the respective bolt head 32 to secure the ring mechanism and ring binder cover together into the finished binder shown in FIGS. 5c and 5d.

As previously described, should the resulting binder 100, 200 need to be recycled, the ring mechanism 104 (which is typically metal or plastic) can easily be separated from the binder cover 110, 210 (which is typically cardboard or plastic or a combination thereof) by unthreading and removing the bolt 30 from the tube 20 of each rivet assembly 10 and pulling the two pieces 104, 110 or 104, 210 apart. Also, as previously mentioned, this operation can be easily and conveniently carried out by just about anyone with any one of a wide variety of commonly available objects.

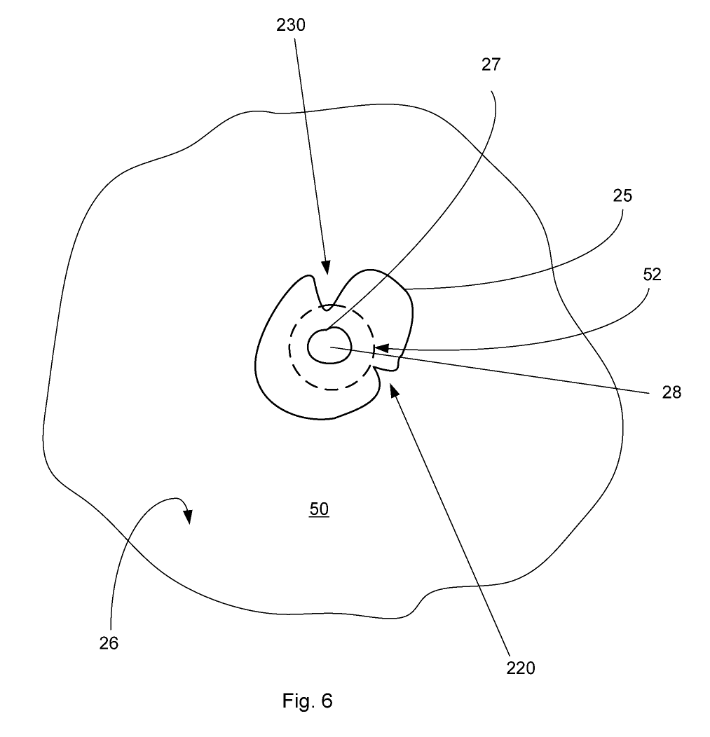

As discussed above in reference to FIGS. 3a and 3b, the rivet assembly 10 is deformed after insertion through workpieces 50, 60. Turning now to FIG. 6, an example embodiment of the deformed portion 25 of the rivet assembly is shown. Looking down at the surface of the workpiece 50, the deformed portion can take on irregular shapes as it flows over the top surface 26 from the force of peening. One or more splits 220 in the deformed portion can form where areas are torn apart, and there can be one or more other areas 230 that do not overlap the top surface of the top workpiece. Only some of the deformed portion needs to overlap the top surface to secure the workpieces together. As can further be seen in FIG. 6, a portion 27 of the deformed portion can flow over the hole 52 in which the rivet assembly is inserted.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments, which may have included tolerances, feature dimensions, specific operating conditions, engineering specifications, or the like, and which can vary between implementations or with changes to the state of the art, and no limitation should be implied therefrom. Applicants have made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ”

What is claimed is:

1. A rivet assembly comprising:
a tube with first and second ends having an inner surface and an axial length, the inner surface including a spiral thread that extends from the first end to a first axial extent; and
a bolt configured to engage the spiral thread to a second axial extent that is less than the axial length of the tube.

2. The rivet assembly of claim 1, wherein the bolt includes a substantially planar head.

3. The rivet assembly of claim 1, wherein the first axial extent is equal to the axial length of the tube.

4. The rivet assembly of claim 1, wherein the first axial extent is equal to the second axial extent.

5. The rivet assembly of claim 1, wherein the tube is made of a malleable material.

6. The rivet assembly of claim 1, wherein the tube and the bolt are made of the same material.

7. The rivet assembly of claim 1, wherein the tube and the bolt are made of different materials.

8. The rivet assembly of claim 1, wherein the first and second ends of the tube are open ends.

9. A method for riveting two objects together, the method comprising:
providing two objects;
providing a tube with first and second ends having an inner surface, an axial length and a diameter, the inner surface including a spiral thread that extends from the first end to a first axial extent;
providing a bolt configured to engage the spiral thread to a second axial extent that is less than the axial length of the tube;
threading the bolt into the first end of the tube;
aligning the two objects;
inserting the tube through the two objects; and
deforming the second end of the tube to at least partially extend beyond the diameter of the tube.

10. The method of claim 9, wherein:
the two objects include a first object having at least two perforations and a second object having at least two perforations;
the step of aligning the two objects includes aligning the at least two perforations of the first object with the at least two perforations of the second object; and
the step of inserting the tube through the two objects includes inserting the tube through the at least two perforations of the first object and the at least two perforations of the second object.

11. The method of claim 9, wherein the step of inserting the tube through the two objects includes punching the tube through at least one of the two objects.

12. The method of claim 9, wherein the bolt includes a substantially planar head.

13. The method of claim 9, wherein the first axial extent is equal to the axial length of the tube.

14. The method of claim 9, wherein the first axial extent is equal to the second axial extent.

15. The method of claim 9, wherein the tube is made of a plastically deformable material.

16. The method of claim 9, wherein the tube and the bolt are made of the same material.

17. The method of claim 9, wherein the tube and the bolt are made of different materials.

18. The method of claim 9, wherein the first and second ends of the tube are open ends.

19. The method of claim 9, wherein the step of threading the bolt into the first end of the tube occurs before the step of inserting the tube through the two objects.

20. A ring binder comprising:
(a) a binder cover including a front cover, a back cover and a spine hingedly connecting the front cover to the back cover;
(b) a ring mechanism attached to the binder cover; and
(c) at least one rivet assembly including:
(i) a tube with first and second ends having an inner surface and an axial length, the inner surface including a spiral thread that extends from the first end to a first axial extent, and
(ii) a bolt configured to engage the spiral thread to a second axial extent that is less than the axial length of the tube;
(d) wherein:
(i) the bolt engages the tube to the second axial extent resulting in the tube having a non-engaged extent,
(ii) the rivet assembly disposed through the ring mechanism and the binder cover, and
(iii) at least a portion of the non-engaged extent is deformed so that the ring mechanism is fastened to the binder cover.

21. A method for forming a ring binder, the method comprising:
(a) providing a binder cover having a front cover, a back cover and a spine hingedly connecting the front cover to the back cover;
(b) providing a ring mechanism;
(c) providing a rivet assembly including:
(i) a tube with first and second ends having an inner surface and an axial length, the inner surface including a spiral thread that extends from the first end to a first axial extent, and
(ii) a bolt engaging the spiral thread to a second axial extent that is less than the axial length of the tube resulting in the tube having a non-engaged extent;
(d) aligning the ring mechanism and the binder cover;
(e) disposing the rivet assembly through the ring mechanism and the binder cover; and
(f) deforming the non-engaged extent of the tube so that the ring mechanism is fastened to the binder cover.
